(19) United States
(12) Patent Application Publication
(10) Pub. No.: US 2026/0173221 A1
(43) Pub. Date: Jun. 18, 2026

(54) HOB DEVICE, HOB, AND METHOD FOR OPERATING A HOB DEVICE

(71) Applicant: BSH Hausgeräte GmbH, Munich (DE)

(72) Inventors: Daniel Anton Falcon, Zaragoza (ES); Cristina Blan Sanmartin, Huesca (ES); Victor Camañes Vera, Zaragoza (ES); Manuel Fernandez Martinez, Zaragoza (ES); Lucia Herrero Lorente, Zaragoza (ES); Eduardo Imaz Martinez, Tudela (Navarra) (ES); Jose Manuel Palacios Gasos, Zaragoza (ES); Diego Puyal Puente, Zaragoza (ES); Javier Serrano Trullen, Zaragoza (ES); Rosario Romeo Velilla, Zaragoza (ES)

(21) Appl. No.: 18/710,643

(22) PCT Filed: Dec. 1, 2022
(86) PCT No.: PCT/EP2022/084056

§ 371 Date: May 16, 2024

(30) Foreign Application Priority Data
Dec. 3, 2021 (EP) 21383103.5

(51) Int. Cl. H05B 6/06; A47J 37/06; F24C 7/08; H05B 6/12

(52) U.S. Cl. CPC H05B 6/062; A47J 37/0676; F24C 7/083; H05B 6/065; H05B 6/1209; H05B 6/1272

(57) ABSTRACT

A cooktop apparatus, in particular an induction cooktop apparatus, includes a placement plate, and a heating unit arranged below the placement plate and including a plurality of heating elements, with a first part of the heating elements forming a first heating group and a second part of the heating elements forming a second heating group. A number of heating elements of the first heating group differs from a number of heating elements of the second heating group, and the first heating group and the second heating group are provided to embody a common cooking surface region.

### PRIOR ART

The invention relates to a cooktop apparatus as claimed in claim 1, a cooktop as claimed in claim 11, and a method for operating a cooktop apparatus as claimed in claim 12.

A “flex” cooktop apparatus having at least two cooking surface regions embodied separately from one another is already known from the prior art. A heating unit comprising in each case at least two heating elements is arranged in each of the at least two cooking surface regions. Furthermore, it has already been proposed that the heating elements of the first heating unit of the one cooking surface region differ from the heating elements of the second heating unit of the second cooking surface region with regard to a number and/or shape and/or size. A “free” cooktop apparatus with a heating unit is also known, wherein the heating unit embodies a single cooking surface region. The heating unit has a large number of heating elements, all of which are embodied identically to one another, namely all having the same shape and size and being arranged in a matrix.

The object of the invention lies in particular in, but is not limited to, providing a generic apparatus with improved properties with regard to convenience. The object is achieved according to the invention by the features of claims 1, 11 and 12, while advantageous embodiments and developments of the invention can be taken from the subclaims.

### ADVANTAGES OF THE INVENTION

A cooktop apparatus, in particular an induction cooktop apparatus, having a placement plate and at least one heating unit arranged below the placement plate, which heating unit has a plurality of heating elements, is proposed, wherein a first part of the heating elements forms a first heating group and at least a second part of the heating elements forms at least a second heating group, wherein a number of heating elements of the first heating group differs from a number of heating elements of the second heating group, and the first heating group and at least the second heating group are provided to embody a common cooking surface region.

Such an embodiment makes it possible to increase convenience, namely user convenience for a user. It is also possible to increase flexibility, namely with regard to a placement and/or a heating of at least one placeable unit. It is moreover possible to increase efficiency, namely for example with regard to product and/or work and/or installation and/or manufacturing and/or cost and/or performance efficiency. It is possible to achieve an effective heating of placed placeable units and/or an advantageous heat distribution. This in turn makes it possible to provide a cost-effective and/or energy-saving embodiment. In addition, it is possible to improve a design with regard to an arrangement of heating elements. Furthermore, on account of a single cooking surface region which is formed jointly by at least two heating groups, it is possible to enable a free and flexible cooking experience for the user and thus to provide a high level of user convenience.

The cooktop apparatus could be embodied as a resistance cooktop apparatus and/or preferably as an induction cooktop apparatus. A “cooktop apparatus” is to be understood to mean at least a part, in particular a subassembly, of a cooktop, advantageously an induction cooktop, wherein in particular accessory units for the cooktop can additionally be included, such as for example a sensor unit for measuring a temperature of an item of cookware and/or food to be cooked. It would also be conceivable for the cooktop apparatus to comprise the entire cooktop. The cooktop apparatus and/or the cooktop is/are provided for use and/or arrangement in a household, in particular a kitchen. The cooktop could in turn be part of a cooktop system, wherein the cooktop system could have a large number of units and/or apparatuses which can be used for food processing purposes. For example, the cooktop system could also have at least one extraction unit and/or at least the sensor unit and/or further sensor units, in particular at least one temperature sensor, which could be provided for positioning in the cookware and/or in the food to be cooked, for example in the form of a roasting spit.

The placement plate is at least one, in particular plate-like, unit which is provided for placing at least one placeable unit and/or for placing at least one item of food, in particular the food to be cooked. The placement plate could be embodied for example as a worktop, in particular as a kitchen worktop, or as a subregion of at least one worktop, in particular at least one kitchen worktop, in particular of the cooktop system. Alternatively and/or in addition, the placement plate could be embodied as a cooktop plate. The placement plate embodied as a cooktop plate could embody in particular at least a part of a cooktop external housing and advantageously, together with at least one external housing unit to which the placement plate embodied as a cooktop plate could in particular be connected in at least one assembled state, could embody the cooktop external housing at least to a large extent. Preferably, the placement plate is made of a non-metallic material. The placement plate could be formed at least partly or at least to a large extent from glass and/or from glass ceramic and/or from Neolith and/or from Dekton and/or from wood and/or from marble and/or from stone, in particular from natural stone, and/or from laminate and/or from plastic and/or from ceramic and/or a compound material. The expression “to a large extent” is to be understood to mean at least 55%, advantageously at least 65%, preferably at least 75%, particularly preferably at least 85% and particularly advantageously at most 95% of a volume and/or mass proportion. In the present document, positional references such as “below” or “above”, for example, relate to an assembled state of the placement plate, provided this is not explicitly described otherwise.

The placeable unit can have a small household appliance and/or the item of cookware. The small household appliance could be for example a coffee machine and/or a toaster and/or a kettle and/or a mixer and/or a stirrer. Advantageously, the small household appliance could be supplied with energy at least partially inductively when placed onto the placement plate. The item of cookware can be embodied for example as a pot and/or pan and/or roaster. If the cooktop apparatus is embodied as an induction cooktop apparatus, the item of cookware could be supplied with energy at least for heating purposes at least partially inductively when placed onto the placement plate. It would also be conceivable for the placeable unit to comprise an underlay unit, which is provided to be laid under the item of cookware and/or the small household appliance.

Advantageously, the underlay unit can be arranged between the placement plate and the item of cookware and/or the small household appliance. In particular, the underlay unit can be arranged in the cooking surface region. Advantageously, the heating unit is provided to heat the placeable unit in the cooking surface region.

The cooktop apparatus could also have further cooking surface regions, namely at least one further cooking surface region, in addition to the cooking surface region. The cooktop apparatus preferably has exactly one cooking surface region, namely the aforementioned cooking surface region, which is formed by the first heating group and at least the second heating group. Particularly preferably, the first heating group and at least the second heating group embody a variable cooking surface region. A “variable cooking surface region” is to be understood to mean a cooking surface region which is provided to form at least one heating zone which is adapted to at least the placed placeable unit, in particular the small household appliance and/or the item of cookware. Advantageously, the variable cooking surface region differs from a cooking surface in which heating zones are fixed, in particular by markings on the cooking surface.

The heating unit could be embodied as a resistance heating unit and/or as an induction heating unit. It is possible for the heating element to be embodied as a resistance heating element. The heating element is advantageously embodied as an inductor. A “heating element” is to be understood to mean an element which is provided to transfer electrical energy at least to a large extent to the placeable unit, at least in one operating mode, preferably through at least the placement plate, in particular the cooktop plate, and/or to convert electrical energy into heat, in order in particular to heat at least the placed placeable unit, preferably through at least the placement plate. In particular, the heating element is provided to transfer a power of at least 100 W, in particular at least 500 W, advantageously at least 1000 W, preferably at least 2000 W, in at least an operating mode in which the heating element is connected to a supply electronics unit of the cooktop apparatus or of the cooktop.

Here an “inductor” is to be understood to mean an element which has at least one induction coil and/or is embodied as an induction coil, and which, in at least one operating mode, is provided to supply energy, in particular in the form of a magnetic alternating field, to at least one receiving element. The receiving element is embodied in particular as a part and/or a subassembly of a receiving unit and is provided in particular to receive the energy supplied by at least one inductor. The receiving unit can be part of the cooktop apparatus. Alternatively, it is conceivable for the receiving unit to be embodied as a unit which is independent of the cooktop apparatus and/or as part of a further apparatus which is independent of the cooktop apparatus. The receiving unit can be provided for placement on a region above the inductor and/or the further inductor. In particular, the receiving unit is part of the placeable unit. The receiving unit could be part of the small household appliance and/or of the item of cookware and/or of the underlay unit. The placeable unit could have at least one secondary coil as a receiving element for receiving the energy supplied by the inductor and/or further inductor. Alternatively or in addition, the receiving element could also be embodied as a metallic heating means, in particular as an at least partially ferromagnetic heating means, for example as a ferromagnetic base of the placeable unit, in particular of the item of cookware and/or of the underlay unit and/or of the small household appliance, in which, in the operating mode of the heating unit, eddy currents and/or remagnetization effects are produced by the inductor and are converted into heat.

The first part of the heating elements and/or the second part of the heating elements could consist in particular of at least one heating element in each case. A heating group could consist of at least one heating element of the plurality of heating elements of the heating unit or of a set of heating elements, namely having at least two heating elements of the plurality of heating elements of the heating unit. The first heating group and/or at least the second heating group preferably has in particular at least two heating elements of the plurality of heating elements of the heating unit in each case.

The cooktop apparatus is provided for connection to an at least two-phase, preferably three-phase, power supply network. The cooktop apparatus has at least two inverter units with in each case at least two inverters, which are provided to operate the heating elements with a high-frequency alternating current. A first inverter unit is connected to a first phase of the power supply network at least in the operating mode and is provided to operate the heating elements of the first heating group. A second inverter unit is connected to a second phase of the power supply network in the operating mode and is provided to operate the heating elements of the second heating group. Preferably, the first inverter unit is arranged on a first circuit board and the second inverter unit is arranged on a second circuit board which is embodied separately from the first circuit board. In particular, the heating unit differs from a matrix heating unit, wherein preferably the first heating group and at least the second heating group are operated by at least the two different inverter units.

The first heating group could possibly have a greater number of heating elements than the second heating group. The second heating group preferably has a greater number of heating elements than the first heating group. It would be conceivable for the first heating group or the second heating group to have just one heating element more than the second heating group or the first heating group. Preferably, a number of heating elements of the first heating group and a number of heating elements of the second heating group differ with regard to at least two heating elements, advantageously with regard to at least four heating elements, preferably with regard to at least six heating elements and particularly preferably with regard to at least eight heating elements. The first heating group or the second heating group could have for example twice as many heating elements as the second heating group or the first heating group.

The cooktop apparatus can have a control unit. A “control unit” is to be understood to mean an electronic unit which is preferably at least partially integrated into a control and/or regulating unit of the cooktop and which is preferably provided to control and/or regulate at least the heating unit, in particular the heating elements of the first heating group and/or at least the heating elements of the second heating group. Preferably, the control unit comprises a computing unit and, in particular, in addition to the computing unit, a storage unit having a control and/or regulating program stored therein which is provided to be executed by the computing unit. The cooktop apparatus advantageously has at least one sensor unit, which is formed in particular by the heating unit itself, in particular the heating elements of the first heating group and/or at least the heating elements of the second heating group, and which is provided to detect the placed placeable unit, in particular by means of measuring at least one inductance and/or at least one capacitance. In particular, the control unit is provided to evaluate measured values of the sensor unit, to calculate at least one heating zone, and to specify at least one heating element of the first heating group and/or at least one heating element of the at least second heating group which form this heating zone. In particular, the control unit is provided to allocate a heating zone, which has an adapted shape, size and/or position, to a detected placeable unit. Advantageously, the control unit is provided, by means of activation of at least one, in particular at least a majority or all, of the heating elements of the first heating group and/or at least of the second heating group, in order to enable at least a detection of the placed placeable unit by the sensor unit. Alternatively, further options which appear expedient to a person skilled in the art for a detection of a placed placeable unit are conceivable, such as for example weight measurements.

The sensor unit is advantageously provided to detect at least a size of the placed placeable unit. In particular, the control unit is provided to determine a size of a placed placeable unit by means of a number of heating elements which are covered by the placeable unit in the cooking surface region. The control unit can be provided to effect at least a regular detection of a placed placeable unit, in particular by the sensor unit. The expression that the control unit is provided to effect at least a “regular” detection of a placed item of cookware is to be understood to mean that the control unit is provided to effect a detection of a placed placeable unit at time intervals of less than 30 s, in particular of less than 10 s, advantageously of less than 5 s, particularly advantageously of less than 1 s, preferably of less than 0.1 s. The expression that the control unit is provided to “effect” at least a regular detection of a placed placeable unit is to be understood to mean that the control unit is provided to enable at least a regular detection of a placed placeable unit by activating at least one of the, in particular at least a majority of the, advantageously all of the heating elements of the first heating group and/or at least of the second heating group.

In the present document, numerals such as for example “first” and “second” which precede specific terms are only used for differentiation between method steps and/or objects and/or assignment between objects with one another and do not imply an existing overall number and/or ranking of the objects and/or of the method steps. In particular, a “second” object and/or method step does not necessarily imply a presence of a “first” object and/or method step. Furthermore, “provided” is to be understood here and in the following to mean especially programmed, configured and/or equipped. That an object is provided for a particular function is to be understood to mean that the object fulfills and/or carries out this particular function in at least one usage and/or operating mode.

It is further proposed that the first heating group is arranged in an edge region of the cooking surface region and the second heating group is arranged in a central region of the cooking surface region. This makes it possible to further increase convenience, namely user convenience. In addition, at least two heating groups can be arranged in an efficient, user-friendly and compact manner in different regions of a cooking surface region, wherein the at least two heating groups together embody the one cooking surface region and at least one placeable unit can be placed flexibly within the cooking surface region by a user.

The central region of the cooking surface regions is surrounded at least on one side by an edge region, in particular the edge region. Advantageously, at least the edge region is arranged directly adjacent to the central region. The edge region could extend, viewed in the width direction of the cooking surface region, in particular of the placement plate, over at least 10%, advantageously at least 20% and preferably at least 30% and particularly preferably at most 45% of the cooking surface region, in particular of the placement plate. Viewed in the depth direction of the cooking surface region, in particular of the placement plate, the edge region could extend over at least 50%, advantageously at least 80% and particularly preferably over the full depth of the cooking surface region, in particular of the placement plate.

Viewed in the width direction, the central region advantageously extends in each case outward, starting from a center point of the cooking surface region, in particular of the placement plate. In particular, viewed in the width direction, the central region extends outward up to at least one edge region, preferably up to at least the aforementioned edge region. The central region could occupy, viewed in the width direction, at least 5%, advantageously at least 10%, preferably at least 30%, and particularly preferably at most 80% of a width of the cooking surface region, in particular of the placement plate. Viewed in the depth direction of the cooking surface region, in particular of the placement plate, the central region could extend over at least 50%, advantageously at least 80% and particularly preferably over the full depth of the cooking surface region, in particular of the placement plate.

The first heating group could fill out at least 30%, advantageously at least 50% and preferably at least 80% of the edge region. The second heating group could fill out at least 30%, advantageously at least 50% and preferably at least 80% of the central region. That a heating group “fills out” a region is to be understood to mean that a percentage proportion of at least 10%, advantageously at least 20% and preferably at least 50% of the region is covered by at least the heating group, in particular at least one heating element of the heating group.

It is also proposed that the heating elements of the first heating group and at least the heating elements of the second heating group differ from one another with regard to a shape and/or size. As a result, convenience, namely user convenience, can be further increased and greater flexibility achieved. In addition, it is possible to increase efficiency, namely performance efficiency, and provide efficient heating of at least one placed placeable unit. It is furthermore possible to achieve an advantageous heat distribution because, on account of different shapes and/or sizes of heating elements of a first heating group and at least one second heating group, a placeable unit can be assigned suitable heating elements as a function of its design, namely its size and/or shape, and thus an efficient and convenient heating can be provided.

For example, the heating elements of the first heating group could have an angular shape and the heating elements of the second heating group could have a round shape, or vice versa. The heating elements of the first heating group and/or of the second heating group could have for example an oval and/or rectangular and/or square shape. At least one round heating element of the first heating group and/or at least of the second heating group could have for example a diameter of at least 7 cm, advantageously at least 8 cm, preferably at least 10 cm and particularly preferably at most 20 cm. It would be conceivable for the heating elements of the first heating group to be smaller than the heating elements of the second heating group. The heating elements of the first heating group are preferably larger than the heating elements of the second heating group. For example, the heating elements of the first heating group could be at least 2%, advantageously at least 10%, preferably at least 30%, and particularly preferably at least 50% larger than the heating elements of the second heating group. It would be conceivable for the heating elements of the first heating group to be at least substantially twice as large as the heating elements of the second heating group. In this context, “at least substantially” is to be understood to mean that a deviation from a predefined value amounts to less than 25%, preferably less than 10% and particularly preferably less than 5% of the predefined value.

At least one heating element of the first heating group and/or of the second heating group could have a width extension of at least 150 mm, advantageously at least 200 mm and preferably at least 250 mm and particularly preferably at most 300 mm, in particular if at least the heating element of the first heating group and/or of the second heating group has a rectangular and/or square shape. At least one heating element, in particular the aforementioned heating element, of the first heating group and/or of the second heating group could have a depth extension of at least 90 mm, advantageously at least 100 mm and preferably at least 120 mm and particularly preferably at most 200 mm, in particular if at least the heating element of the first heating group and/or of the second heating group has a rectangular and/or square shape.

Preferably, the heating elements, namely at least two heating elements and advantageously all heating elements of a heating group, in particular of the first heating group or at least of the second heating group, are embodied at least substantially to be identical to one another. The at least two heating elements and advantageously all heating elements of a heating group, in particular of the first heating group or at least of the second heating group, can have identical components. Advantageously, at least two heating elements and advantageously all heating elements of a heating group, in particular of the first heating group or at least of the second heating group, differ only with respect to their arrangement below the placement plate and in particular within the cooking surface region.

It is further proposed that at least two adjacent heating elements of the second heating group have a smaller distance from one another than at least two adjacent heating elements of the first heating group when viewed in the depth direction and/or in the width direction of the cooking surface region. This makes it possible to further increase convenience, efficiency and flexibility. Furthermore, a compact design can be provided.

At least two adjacent heating elements of a heating group are to be understood to mean two heating elements of the heating group which are arranged adjacent to one another. The expression that two heating elements of a heating group are arranged “adjacent to one another” is to be understood to mean that a shortest straight line connecting the heating elements, starting from a first of the heating elements of the heating group, intersects only the first heating element and a second of the heating elements of the heating group, which is embodied separately from the first heating element, in particular avoiding a further heating element of the heating group between the two heating elements, wherein a distance between the further heating element of the heating group and at least one of the adjacently arranged heating elements is at least as great as a distance between the adjacently arranged heating elements.

At least two adjacent heating elements of the first heating group could have a first distance from one another. At least two adjacent heating elements of the second heating group could have a second distance, in particular the aforementioned distance, from one another. The second distance could be at least substantially at least 2%, advantageously at least 5% and preferably at least 10% and particularly preferably at least 30% smaller than the first distance between the at least two adjacent heating elements of the first heating group. It would be conceivable for the first distance to be measurable in the depth direction. The second distance could be measured in the width direction. Alternatively, the first distance could be measured in the width direction and the second distance in the depth direction. Preferably, the first distance and the second distance are measured in each case in the width direction. Alternatively, the first distance and the second distance could be measured in each case in the depth direction.

At least one heating element of the first heating group, viewed in the width direction of the cooking surface region, could have a width extension which is at least substantially at least 10%, in particular at least 20% and advantageously at least 30% greater than a width extension of at least one heating element of the second heating group. For increased convenience and an improved design, it is proposed that at least one heating element of the first heating group, viewed in the width direction of the cooking surface region, has a width extension which is at least substantially 50% greater than a width extension of at least one heating element of the second heating group. As a result, heating elements of different widths can be arranged within a cooking surface region in order precisely to enable an efficient and convenient heating of placeable units with different sizes and/or shapes. The width extension of at least one heating element of the second heating group could also be understood to mean a diameter viewed in the width direction of at least one heating element, in particular of a round heating element, of the second heating group. It would also be conceivable for at least one heating element of the first heating group, viewed in the width direction of the cooking surface region, to have a width extension which is at least substantially at least 51%, in particular at least 60% and advantageously at least 70% greater than a width extension of at least one heating element of the second heating group.

At least one heating element of the first heating group, viewed in the depth direction of the cooking surface region, could have a depth extension which is at least substantially at least 10%, in particular at least 20% and advantageously at least 30% greater than a depth extension of at least one heating element of the second heating group. In further embodiments of the invention, it is proposed that at least one heating element of the first heating group, viewed in the depth direction of the cooking surface region, has a depth extension which is at least substantially identical to a depth extension of at least one heating element of the second heating group. This makes it possible to provide a particularly convenient and compact design. Furthermore, heating elements within a cooking surface region can be arranged over as large an area as possible and/or as evenly as possible, which in turn makes it possible to provide an efficiency, namely with regard to a heating of at least one placeable unit and/or an advantageously even heat distribution. This makes it possible to further increase convenience, namely user convenience. The depth extension of at least one heating element of the second heating group could also be understood to mean a diameter viewed in the depth direction of at least one heating element, in particular of a round heating element, of the second heating group.

In a further embodiment of the invention, it is proposed that at least the heating elements of the first heating group are arranged in an in particular single row. This makes it possible to provide a compact design and further increase convenience.

A “row” is to be understood to mean a line and/or a column and/or a strip. In particular, the heating elements of the first heating group are arranged close together, in particular lined up, along a row longitudinal direction which connects the heating elements and in particular is embodied as a straight line. In particular, the row longitudinal direction connects the focal points of the heating elements. It is likewise conceivable for the heating elements to be arranged in an offset manner, wherein focal points of the heating elements are at a distance from a straight line, which is oriented at least substantially parallel to the row longitudinal direction and which interconnects the heating elements at least substantially in their centers, which distance is less than 50%, in particular less than 40%, advantageously less than 30% of an amount of at least one extension, in particular a longitudinal extension and/or a transverse extension, of at least one of the heating elements embodying the row. A “single” row consisting of at least two heating elements is to be understood to mean a row in which the heating elements are arranged next to one another in an in particularly precisely one row longitudinal direction, wherein the control unit is provided in order to form at least one heating zone, which is adapted to at least one placed placeable unit, from the heating elements arranged next to one another in the row longitudinal direction.

To increase flexibility and thus in turn convenience, namely user convenience, it is proposed that at least the heating elements of the second heating group are arranged at least partially in the form of a matrix. This makes it possible to provide a high level of flexibility and further increase convenience, namely user convenience.

That at least the heating elements of the second heating group are arranged at least partially in the form of a matrix is to be understood here to mean that the heating elements of the second heating group are arranged adjacent to one another in at least two columns and/or at least two rows. Preferably, at least the heating elements of the second heating group embody at least partially and advantageously fully a heating element matrix. A “heating element matrix” is to be understood to mean a preferably two-dimensional, advantageously regular arrangement, in particular in a quadratic or hexagonal pattern, of at least four, in particular at least six, advantageously at least eight and particularly preferably at least nine heating elements.

If a third part of the heating elements form a third heating group which is embodied to be identical to the first heating group, a particularly convenient and simple design can be provided and efficiency increased. The heating elements of the third heating group could be embodied to be identical to the heating elements of the first heating group at least with regard to a number and/or a shape and/or a size. The heating elements of the third heating group preferably have a rectangular shape. The cooktop apparatus can have a third inverter unit with at least two inverters. The third inverter unit is connected to a third phase of the power supply network in the operating mode and is provided to operate the heating elements of the third heating group.

It is also proposed that the third heating group is arranged in a further edge region, in particular lying opposite the edge region, of the heating zone. This makes it possible to provide a particularly convenient arrangement for placing at least one placeable unit and thus optimize convenience, namely user convenience. Furthermore, it is possible to achieve an effective heating of placed placeable units and/or an advantageous heat distribution, which in turn enables efficiency to be increased. The edge region and the further edge region preferably at least partially delimit the central region. In particular, the central region is arranged between the edge region and the further edge region.

The invention further relates to a method for operating a cooktop apparatus, in particular the aforementioned cooktop apparatus.

Such a method makes it possible to increase convenience, namely user convenience. Furthermore, it is possible to provide a high level of flexibility when placing a placeable unit for heating. It is also possible to increase efficiency, namely for example with regard to product and/or work and/or installation and/or manufacturing and/or cost and/or performance efficiency. Moreover, a particularly convenient and efficient method for operating the cooktop apparatus can be provided on the basis of a common cooking surface region. The method for operating the cooktop apparatus could have several method steps and/or method substeps. The method preferably comprises at least one operating step. The operating step could in turn consist of several operating substeps. In particular, in the method for operating the cooktop apparatus, at least one heating zone is formed adapted to a shape and/or size and/or position of a placeable unit. In at least the operating step, at least one heating element of the first heating group and/or at least one heating element of the second heating group and/or at least one heating element of the third heating group is actuated and/or regulated and/or activated for heating at least the placeable unit. If the placeable unit covers at least one heating element or more than one heating element of the first heating group and/or at least one heating element or more than one heating element of the second heating group and/or at least one heating element or more than one heating element of the third heating group, in the operating step the covered heating elements of the first heating group and/or the heating elements of the second heating group and/or the heating elements of the third heating group can combined to form a common heating zone and operated and/or actuated and/or regulated jointly for heating the placeable unit.

Here, the cooktop apparatus and/or the cooktop and/or the method should not be restricted to the use and embodiment described above. In particular, the cooktop apparatus and/or the cooktop and/or the method can have a number of individual elements, parts, units and method steps deviating from a number mentioned herein for fulfilling a mode of operation described herein. Where value ranges are specified in this document, values lying within the specified limits are also to be deemed disclosed and usable in any desired manner.

### DRAWINGS

Further advantages will emerge from the following description of the drawings. The drawings show several exemplary embodiments of the invention. The drawings, the description and the claims contain numerous features in combination. The person skilled in the art will expediently also consider the features individually and combine them to form useful further combinations.

In the drawings:

FIG. 1 shows a schematic representation of a cooktop with a cooktop apparatus, which has a placement plate and a heating unit arranged below the placement plate, wherein a placeable unit is placed on the placement plate,

FIG. 2 shows an arrangement of a plurality of heating elements of the heating unit below the placement plate,

FIG. 3 shows a schematic representation of a method for operating the cooktop apparatus,

FIG. 4 shows a cooktop apparatus in a further exemplary embodiment,

FIG. 5 shows a cooktop apparatus in a further exemplary embodiment, and

FIG. 6 shows a cooktop apparatus in a further exemplary embodiment.

### DESCRIPTION OF THE EXEMPLARY EMBODIMENTS

In the following, only two of the objects present multiple times in the figures are provided with a reference character in each case. Furthermore, the figures described here are schematic representations and are not true to scale.

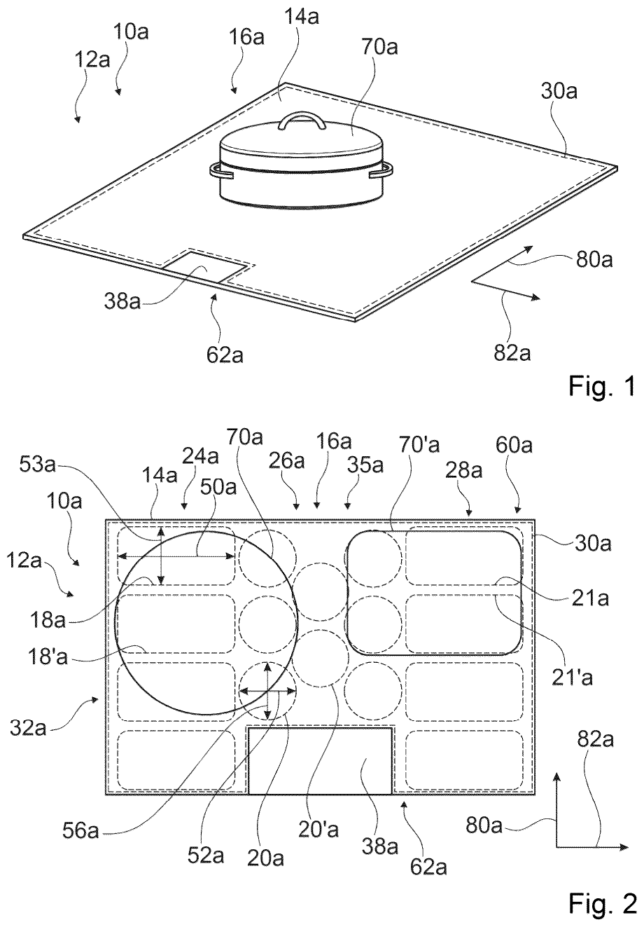

FIG. 1 shows a cooktop 10a with a cooktop apparatus 12a. Here, the cooktop apparatus 12a is embodied as an induction cooktop apparatus 12a and the cooktop 10a as an induction cooktop. The cooktop apparatus 12a has a placement plate 14a for placing at least one placeable unit 70a. In this exemplary embodiment, the placement plate 14a is embodied as a cooktop plate. Alternatively and/or in addition, the placement plate 14a could be embodied at least in sections as a worktop, namely as a kitchen worktop. The placement plate 14a embodies a cooking surface for placing at least the placeable unit 70a. The cooktop apparatus 12a has a cooking surface region 30a. Here, the placement plate 14a has the cooking surface region 30a. The placement plate 14a has exactly one, namely the cooking surface region 30a. Here, the cooking surface region 30a is embodied identically to the cooking surface.

The placeable unit 70a, as shown in FIG. 1, is embodied by way of example as an item of cookware, namely as a pot. Alternatively and/or in addition, it would also be conceivable for the placeable unit to be a small household appliance, such as for example a kettle and/or a coffee machine and/or a mixer and/or a stirrer.

The cooktop apparatus 12a has a heating unit 16a with a plurality of heating elements 18a, 18′a, 20a, 20′a, 21a, 21′a. The heating unit 16a is embodied as an induction heating unit. The heating unit 16a is arranged below the placement plate 14a. FIG. 2 shows a schematic representation illustrating the arrangement of the heating unit 16a with the plurality of heating elements 18a, 18′a, 20a, 20′a, 21a, 21′a below the placement plate 14a. Here, in the interest of clarity, only six heating elements 18a, 18′a, 20a, 20′a, 21a, 21′a of the heating unit 16a are provided with reference characters. The heating unit 16a is embodied as an induction heating unit. Furthermore, the heating elements 18a, 18′a, 20a, 20′a, 21a, 21′a are embodied as induction heating elements. The heating elements 18a, 18′a, 20a, 20′a, 21a, 21′a are in each case provided to heat at least one placeable unit 70a placed on the placement plate 14a above the heating elements 18a, 18′a, 20a, 20′a, 21a, 21′a.

A first part of the heating elements 18a, 18′a forms a first heating group 24a. At least one second part of the heating elements 20a, 20′a forms at least one second heating group 26a. The first heating group 24a and at least the second heating group 26a are provided to together embody precisely one cooking surface region 30a, namely the cooking surface region 30a. In this exemplary embodiment, the heating unit 16a has a third part of heating elements 21a, 21′a, which embodies a third heating group 28a. The third heating group 28a could be embodied differently from the first heating group 24a and/or the second heating group 26a. Here, the third heating group 28a is embodied to be identical to the first heating group 24a. In the interest of clarity, only two heating elements in each case both of the first heating group 24a and also of the second heating group 26a and of the third heating group 28a are provided with a reference character. Here, the first heating group 24a, the second heating group 26a and the third heating group 28a together embody the cooking surface region 30a.

The cooking surface region 30a is a variable cooking surface region and here is free from markings and/or fixed positions for placing at least the placeable unit 70a. The variable cooking surface region 30a is provided to form at least one heating zone which is adapted to at least the placed placeable unit 70a.

FIG. 2 shows by way of example two placeable units 70a, 70′a, which differ in terms of a shape and size and are placed on the placement plate 14a. The variable cooking surface region 30a is provided to form heating zones which are adapted in each case to the placeable units 70a, 70′a. FIG. 2 illustrates that, in this exemplary representation, the placeable unit 70a covers both at least two heating elements 18a, 18′a of the first heating group 24a and at least two heating elements 20a, 20′a of the second heating group 26a. Furthermore, the placeable unit 70′a simultaneously covers at least two heating elements 21a, 21′a of the third heating group 28a and at least two heating elements 20a, 20′a of the second heating group 26a, namely here at least two other heating elements 20a, 20′a of the second heating group 26a than the placeable unit 70a.

The cooktop apparatus 12a has a control unit 62a. The control unit 62a is integrated at least partially in a control and/or regulating unit of the cooktop 10a, and is provided to control and/or regulate at least the heating unit 16a, namely the heating elements 18a, 18′a of the first heating group 24a, the heating elements 20a, 20′a of the second heating group 26a and at least the heating elements 21a, 21′a of the third heating group 28a. Here, the control unit 62a is provided to calculate at least one heating zone and specify heating elements 18a, 18′a of the first heating group 24a and/or heating elements 20a, 20′a of the second heating group 26a and/or at least heating elements 21a, 21′a of the third heating group 28a which form this heating zone. The control unit 62a is provided to allocate a heating zone, which has an adapted shape, size and/or position, to a detected placeable unit 70a, 70′a.

For the purpose of heating the placeable unit 70a, 70a′, the control unit 62a is provided to actuate and/or regulate at least one heating group 24a, 26a, 28a. In this exemplary embodiment, the control unit 62a controls and/or regulates at least two heating elements 18a, 18′a of the first heating group 24a and at least two heating elements 20a, 20′a of the second heating group 26a for the purpose of heating the placeable unit 70a. The control unit 62a controls and/or regulates at least two heating elements 21a, 21′a of the third heating group 28a and at least two heating elements 20a, 20′a of the second heating group 26a at least for the purpose of heating the placeable unit 70′a.

The cooktop apparatus 12a has an operator interface 38a. The operator interface 38a is provided for an input and/or an output by and/or to an operator. FIG. 2 shows that the first heating group 24a is arranged in an edge region 32a of the cooking surface region 30a and the second heating group 26a is arranged in a central region 35a of the cooking surface region 30a. In this exemplary embodiment, the central region 25a extends from the operator interface 38a over an entire depth of the cooking surface region 30a up to an edge of the placement plate 14a. The third heating group 28a is arranged in a further edge region 60a, namely lying opposite the edge region 32a, of the cooking surface region 30a.

Here, a number of heating elements 18a, 18′a of the first heating group 24a differs from a number of heating elements 20a, 20′a of the second heating group 26a. The heating elements 18a, 18′a of the first heating group 24a and at least the heating elements 20a, 20′a of the second heating group 26a differ from one another with regard to a shape and/or size. In this exemplary embodiment, the heating elements 18a, 18′a of the first heating group 24a have a rectangular shape. The heating elements 20a, 20′a of the second heating group 26a have a round shape.

At least the heating elements 18a, 18′a of the first heating group 24a are arranged in a single row 60a (cf. FIG. 2). Here, the heating elements 20a, 20′a of the second heating group 26a are arranged at least partially in the form of a matrix.

The cooking surface region 30a has a width direction 82a and a depth direction 80a. In this exemplary embodiment, at least one heating element 18a, 18′a of the first heating group 24a, viewed in the width direction 82a of the cooking surface region 30a, has a width extension 50a which is at least substantially 50% greater than a width extension 52a of at least one heating element 20a, 20′a of the second heating group 26a. In the interest of clarity, the width extension 50a is drawn in by way of example for the heating element 18a and the width extension 52a by way of example for the heating element 20a, wherein the width extension 52a is the diameter of the heating element 20a (cf. FIG. 2). If a heating element is embodied with a circular shape, the width extension can also be understood to mean the diameter, viewed in the width direction.

FIG. 2 shows that at least one heating element 18a, 18′a of the first heating group 24a, viewed in the depth direction 80a of the cooking surface region 30a, has a depth extension 53a which is at least substantially identical to a depth extension 56a of at least one heating element 20a, 20′a of the second heating group 26a. In the interest of clarity, the depth extension 53a is drawn in by way of example for the heating element 18a and the depth extension 56a by way of example for the heating element 20a, wherein the depth extension 56a is the diameter of the heating element 20a (cf. FIG. 2). If a heating element is embodied with a circular shape, the depth extension can also be understood to mean the diameter, viewed in the depth direction.

Here, all heating elements 18a, 18′a of the first heating group 24a are embodied to be identical to one another. Furthermore, all heating elements 20a, 20′a of the second heating group 26a are embodied to be identical to one another. The heating elements 21a, 21′a of the third heating group 28a are embodied to be identical to the heating elements 18, 18′a of the first heating group 24a. The first heating group 24a and the third heating group 28a differ from one another only in terms of their arrangement in the cooking surface region 30a.

FIG. 3 shows a schematic representation of a method flowchart of a method for operating the cooktop apparatus 12a. The operating method could comprise several method steps. Here, the method is described by way of example only on the basis of one method step 100a. In the method for operating the cooktop apparatus 12a, at least one heating zone is formed adapted to a shape and/or size and/or position of a placeable unit 70a, 70′a. In at least the method step 100a, at least one heating element 18a, 18′a of the first heating group 24a and/or at least one heating element 20a, 20′a of the second heating group 26a and/or at least one heating element 21a, 21′a of the third heating group 28a is actuated and/or regulated and/or activated for heating at least the placeable unit 70a, 70′a. If the placeable unit 70a, 70′a covers at least one heating element 18a, 18′a or more than one heating element 18a, 18′a of the first heating group 24a and/or at least one heating element 20a, 20′a or more than one heating element 20a, 20′a of the second heating group 26a and/or at least one heating element 21a, 21′a or more than one heating element 21a, 21′a of the third heating group 28a, then in the method step 100a the covered heating elements 18a, 18′a of the first heating group 24a and/or the heating elements 20a, 20′a of the second heating group 26a and/or the heating elements 21a, 21′a of the third heating group 28a can combined to form a common heating zone and operated and/or actuated and/or regulated jointly for heating the placeable unit 70a, 70′a.

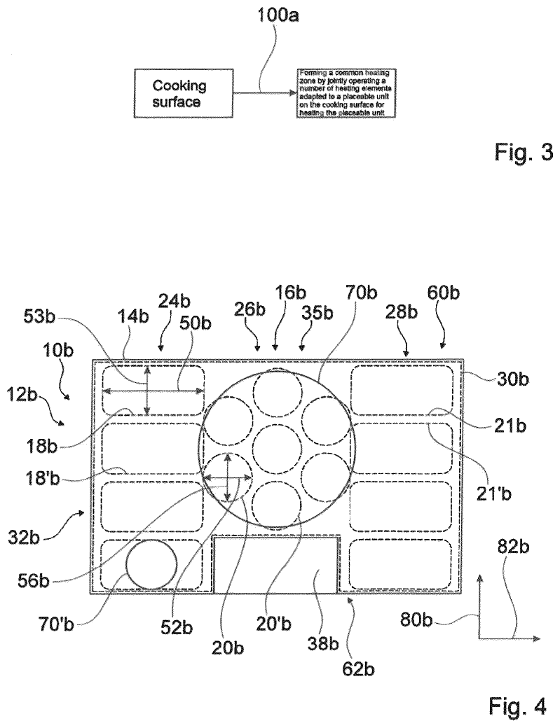

FIGS. 4 to 6 show further exemplary embodiments of the invention. The following descriptions are essentially restricted to the differences between the exemplary embodiments, wherein with regard to components, features and functions which remain the same, reference can be made to the description of the exemplary embodiment in FIGS. 1 to 3. In order to differentiate the exemplary embodiments, the letter a in the reference characters of the exemplary embodiment in FIGS. 1 to 3 is replaced by the letters b to d in the reference characters of the exemplary embodiments in FIGS. 4 to 6. In principle, reference can also be made to the drawings and/or the description of the exemplary embodiment in FIGS. 1 to 3, in respect of components labeled the same, in particular in respect of components with identical reference characters.

FIG. 4 shows a cooktop 10b with a cooktop apparatus 12b of a further exemplary embodiment. The cooktop apparatus 12b has a heating unit 16b with a plurality of heating elements 18b, 18′b, 20b, 20′b, 21b, 21′b. A second part of the heating elements 20b, 20′b forms a second heating group 26b. Here, the heating elements 20b, 20′b of the second heating group 26b are arranged in the form of a matrix. The cooktop apparatus 12b differs from the cooktop apparatus 12a only in terms of an arrangement of the heating elements 20b, 20′b of the second heating group 26b in a central region 35b of a cooking surface region 30b of the cooktop apparatus 12b.

Furthermore, FIG. 4 shows by way of example two placeable units 70b, 70′b which, in comparison to the exemplary embodiment a represented in FIGS. 1 to 3, have different shapes and/or sizes and/or positions on the cooking surface region 30b.

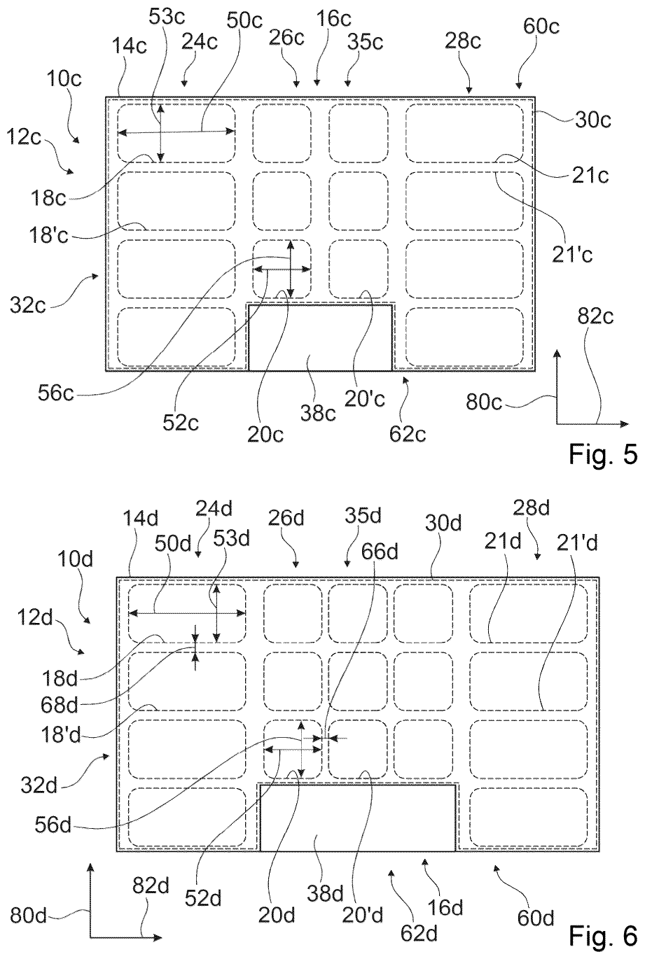

FIG. 5 shows a cooktop 10c with a cooktop apparatus 12c of a further exemplary embodiment. The cooktop apparatus 12c has a heating unit 16c with a plurality of heating elements 18c, 18′c, 20c, 20′c, 21c, 21′c. A second part of the heating elements 20c, 20′c embodies a second heating group 26c. The cooktop apparatus 12c differs from the cooktop apparatus 12a in terms of an embodiment and an arrangement of the heating elements 20c, 20′c of the second heating group 26c in a central region 35c of a cooking surface region 30c of the cooktop apparatus 12c. Here, the heating elements 20c, 20′c of the second heating group 26c have a square shape.

FIG. 6 shows a cooktop 10d with a cooktop apparatus 12d of a further exemplary embodiment. The cooktop apparatus 12d has a heating unit 16d with a plurality of heating elements 18d, 18′d, 20d, 20′d, 21d, 21′d. A first part of the heating elements 18d, 18′d embodies a first heating group 24d. A second part of the heating elements 20d, 20′d embodies a second heating group 26d. The cooktop apparatus 12d differs from the cooktop apparatus 12a in terms of an embodiment and an arrangement of the heating elements 20d, 20′d of the second heating group 26d in a central region 35d of a cooking surface region 30d of the cooktop apparatus 12d. Here, the heating elements 20d, 20′d of the second heating group 26d have a square shape. In comparison to the exemplary embodiment c represented in FIG. 5, the second heating group 26d has a greater number of heating elements 20d, 20′d. In this exemplary embodiment, at least two adjacent heating elements 20d, 20′d of the second heating group 26d, viewed in the width direction 82d, have a smaller distance 66d from one another than at least two adjacent heating elements 18d, 18′d of the first heating group 24d. The at least two adjacent heating elements 18d, 18′d of the first heating group 24d have a distance 68d from one another. Here, the distance 66d is smaller than the distance 68d.

### REFERENCE CHARACTERS

10 Cooktop
12 Cooktop apparatus
14 Placement plate
16 Heating unit
18 Heating element
20 Heating element
21 Heating element
24 Heating group
26 Heating group
28 Heating group
30 Cooking surface region
32 Edge region
35 Central region
38 Operator interface
50 Width extension
52 Width extension
53 Depth extension
56 Depth extension
60 Edge region
62 Control unit
66 Distance
68 Distance
70 Placeable unit
80 Depth direction
82 Width direction
100 Method step

1-12. (canceled)

13. A cooktop apparatus, in particular an induction cooktop apparatus, the cooktop apparatus comprising:
a placement plate; and
a heating unit arranged below the placement plate and comprising a plurality of heating elements, with a first part of the heating elements forming a first heating group and a second part of the heating elements forming a second heating group, wherein a number of heating elements of the first heating group differs from a number of heating elements of the second heating group, and wherein the first heating group and the second heating group are provided to embody a common cooking surface region.

14. The cooktop apparatus of claim 13, wherein the first heating group is arranged in an edge region of the cooking surface region and the second heating group is arranged in a central region of the cooking surface region.

15. The cooktop apparatus of claim 13, wherein the heating elements of the first heating group and the heating elements of the second heating group differ from one another with regard to a shape and/or size.

16. The cooktop apparatus of claim 13, wherein at least two adjacent ones of the heating elements of the second heating group have from one another a distance which is smaller than a distance of at least two adjacent ones of the heating elements of the first heating group.

17. The cooktop apparatus of claim 13, wherein at least one heating element of the first heating group, viewed in a width direction of the cooking surface region, has a width extension which is substantially at least 50% greater than a width extension of at least one heating element of the second heating group.

18. The cooktop apparatus of claim 13, wherein at least one heating element of the first heating group, viewed in a depth direction of the cooking surface region, has a depth extension which is at least substantially identical to a depth extension of at least one heating element of the second heating group.

19. The cooktop apparatus of claim 13, wherein the heating elements of the first heating group are arranged in a row.

20. The cooktop apparatus of claim 13, wherein the heating elements of the second heating group are arranged at least partially in a form of a matrix.

21. The cooktop apparatus of claim 13, wherein a third part of the heating elements forms a third heating group, the third part of the heating elements embodying to be identical to the first heating group.

22. The cooktop apparatus of claim 15, wherein a third part of the heating elements form a third heating group, the third part of the heating elements embodying to be identical to the first heating group and being arranged in a further edge region, in particular lying opposite the edge region of the cooking surface region.

23. A cooktop, in particular an induction cooktop, the cooktop comprising a cooktop apparatus, said cooktop apparatus comprising a placement plate, and a heating unit arranged below the placement plate and comprising a plurality of heating elements, with a first part of the heating elements forming a first heating group and a second part of the heating elements forming a second heating group, wherein a number of heating elements of the first heating group differs from a number of heating elements of the second heating group, and wherein the first heating group and the second heating group are provided to embody a common cooking surface region.

24. A method for operating a cooktop apparatus, the method comprising:
forming a heating zone below a placement plate by a plurality of heating elements; and
activating a selected group of the heating elements for heating the placement plate,
wherein a first part of the heating elements forms a first heating group and a second part of the heating elements forms a second heating group,
wherein a number of heating elements of the first heating group differs from a number of heating elements of the second heating group, and
wherein the first heating group and the second heating group are provided to embody a common cooking surface region.

25. The method of claim 24, further comprising:
arranging the first heating group in an edge region of the cooking surface region; and
arranging the second heating group in a central region of the cooking surface region.

26. The method of claim 24, wherein the heating elements of the first heating group and the heating elements of the second heating group differ from one another with regard to a shape and/or size.

27. The method of claim 24, wherein at least two adjacent ones of the heating elements of the second heating group have from one another a distance which is smaller than a distance of at least two adjacent ones of the heating elements of the first heating group.

28. The method of claim 24, wherein at least one heating element of the first heating group, viewed in a width direction of the cooking surface region, has a width extension which is substantially at least 50% greater than a width extension of at least one heating element of the second heating group.

29. The method of claim 24, wherein at least one heating element of the first heating group, viewed in a depth direction of the cooking surface region, has a depth extension which is at least substantially identical to a depth extension of at least one heating element of the second heating group.

30. The method of claim 24, further comprising arranging the heating elements of the first heating group in a row.

31. The method of claim 24, further comprising arranging the heating elements of the second heating group at least partially in a form of a matrix.

32. The method of claim 25, further comprising forming a third heating group by a third part of the heating elements, the third part of the heating elements embodying to be identical to the first heating group.

33. The method of claim 32, further comprising arranging the third part of the heating elements in a further edge region, in particular lying opposite the edge region, of the cooking surface region.
